(19) United States
(12) Patent Application Publication
(10) Pub. No.: US 2015/0145750 A1
(43) Pub. Date: May 28, 2015

(54) SYSTEM AND METHOD FOR IMAGE PROCESSING, AND VEHICLE ELECTRONIC DEVICE AND PORTABLE TERMINAL SUPPORTING THE SAME

(71) Applicant: Hyundai Motor Company, Seoul (KR)

(72) Inventor: Soo Young Shin, Seongnam (KR)

(73) Assignee: HYUNDAI MOTOR COMPANY, Seoul (KR)

(21) Appl. No.: 14/290,278

(22) Filed: May 29, 2014

(30) Foreign Application Priority Data
Nov. 26, 2013 (KR) 10-2013-0144726

(51) Int. Cl. G06F 3/14; B60R 1/00; G09G 5/391

(52) U.S. Cl. CPC G06F 3/1454; G09G 5/391; B60R 1/00; G09G 2340/145
USPC 345/2.2

(57) ABSTRACT

Provided are an image processing method and a system, and a vehicle electronic device and a portable terminal supporting the same. The system for an image processing includes: a portable terminal configured to generate a dummy image based on resolution information of a vehicle electronic device and a size of its own display unit to transmit to the vehicle electronic device, and transmits an adjusted image depending on an image size based on the dummy image transmitted by the vehicle electronic device; and a vehicle electronic device configured to calculate the image size based on the dummy image to transmit to the portable terminal, and receive and output the adjusted image transmitted by the portable terminal.

### CROSS-REFERENCE TO RELATED APPLICATION

This application claims the benefit of priority to Korean Patent Application No. 10-2013-0144726, filed on Nov. 26, 2013 in the Korean Intellectual Property Office, the disclosure of which is incorporated herein in its entirety by reference.

### BACKGROUND OF THE INVENTION

1. Field of the Invention

The present invention relates to an image processing between a vehicle and a portable terminal, and more particularly, to an image processing method and a system that support an image displayed in the portable terminal to be processed, transmitted, and output in more suitable form to an image processing device installed in a vehicle, and a vehicle electronic device and a portable terminal supporting the same.

2. Description of the Related Art

Various electronic devices are mounted on a vehicle, in particular, the electronic devices outputting an image are disposed therein. The electronic device disposed in the vehicle may output an image signal received by an antenna, or may output an image signal delivered by another device. For instance, the image being output from the portable terminal may be mirrored to and output from the vehicle electronic device. In this process, since the image being output from the portable terminal is mirrored to and output from the vehicle electronic device, it may not have an image size appropriate to the vehicle electronic device.

In particular, a display area of the vehicle electronic device has a difference with a display area of the portable terminal, which may cause the image display to be discrepant to an entire display area. That is, since the portable terminal or the vehicle electronic device has a fixed size for a screen transmission based on their standard, the image signal that does not match to a resolution of the screen to be actually displayed is transmitted and received. Accordingly, a UI screen distortion phenomenon due to a different screen ratio of the several portable terminals may occur. Moreover, even though the screen image is projected based on the resolution which is mutually shared between the portable terminal and the vehicle electronic device, since the resolution of the apparatus is transformed in a pre-designated type and transmitted, there is a problem in that a blank screen in right and left sides may occur.

### SUMMARY OF THE INVENTION

The present invention has been made in view of the above problems, and provides a method for preventing a distortion of a screen resulted from a different kind of display apparatus in a screen mirroring technology among a connectivity technology between a portable terminal and a vehicle electronic device, and providing an optimized GUI to a vehicle electronic device having a non-standardized resolution.

In accordance with an aspect of the present invention, a system for processing an image includes: a portable terminal configured to generate a dummy image based on resolution information of a vehicle electronic device and a size of its own display unit to transmit to the vehicle electronic device, and transmits an adjusted image depending on an image size based on the dummy image transmitted by the vehicle electronic device; and a vehicle electronic device configured to calculate the image size based on the dummy image to transmit to the portable terminal, and receive and output the adjusted image transmitted by the portable terminal. The portable terminal adjusts the dummy image so that a resolution size of the display unit may be fit to the resolution of the vehicle electronic device. The portable terminal transmits a left and right diagonal direction coordinates value of the adjusted image along with the adjusted image. The vehicle electronic device outputs the adjusted image to a vehicle display module based on the direction coordinates value. The vehicle electronic device performs a scaling of the adjusted image based on a size comparison of the adjusted image and the vehicle display module.

In accordance with another aspect of the present invention, a portable terminal supporting an image process includes: a communication module configured to form a communication channel with a vehicle electronic device; and a controller configured to receive resolution information of the vehicle electronic device through the communication module, generate a dummy image based on the resolution information of the vehicle electronic device and a size of the portable terminal's own display unit to transmit to the vehicle electronic device, and generate and transmit an adjusted image depending on an image size based on the dummy image transmitted by the vehicle electronic device and a resolution of the vehicle electronic device. The controller generates a dummy image having a maximum size of resolution of the display unit, or generates a dummy image obtained by adjusting a size corresponding to the resolution of the display unit to the resolution of the vehicle electronic device. The controller controls a left and right diagonal direction coordinates value of the adjusted image to be transmitted along with the adjusted image. The communication module performs a mirroring data transmission based on HDMI or MHL.

In accordance with another aspect of the present invention, a vehicle electronic device supporting an image processing includes: a vehicle communication module configured to form a communication channel with a portable terminal and; a vehicle controller configured to transmit resolution information of a vehicle electronic device through the vehicle communication module, receive a dummy image generated based on the resolution information of the vehicle electronic device and a display unit size of the portable terminal from the portable terminal to perform an image processing and transmit a measured image size to the portable terminal, and receive an adjusted image from the portable terminal; and a vehicle display module configured to output the adjusted image. The vehicle controller controls an output of the adjusted image by using a left and right diagonal direction coordinates value of the image received along with the adjusted image. The vehicle controller performs a scaling of the adjusted image based on a size comparison of the adjusted image and the vehicle display module. The vehicle communication module performs a mirroring data reception based on HDMI or MHL.

In accordance with another aspect of the present invention, a method of processing an image includes: forming a communication channel with a portable terminal by a vehicle electronic device; receiving a dummy image generated based on a resolution of display unit of the portable terminal by the vehicle electronic device; calculating an image size by image processing the dummy image by the vehicle electronic device; transmitting the image size to the portable terminal by the vehicle electronic device; receiving an adjusted image obtained by adjusting a size based on the image size by the vehicle electronic device; and outputting the received adjusted image by the vehicle electronic device. The receiving of the adjusted image further comprises receiving a left and right diagonal direction coordinates value of the adjusted image. The method of processing an image further includes performing performs a scaling of the adjusted image based on a size comparison of the adjusted image and the vehicle display module of the vehicle electronic device.

### BRIEF DESCRIPTION OF THE DRAWINGS

The objects, features and advantages of the present invention will be more apparent from the following detailed description in conjunction with the accompanying drawings, in which:

FIG. 1 is a diagram schematically illustrating a configuration of an image processing system according to an exemplary embodiment of the present invention;

FIG. 2 is a diagram schematically illustrating a configuration of a portable terminal in an image processing system configuration according to an exemplary embodiment of the present invention;

FIG. 3 is a diagram schematically illustrating a vehicle configuration in an image processing system configuration according to an exemplary embodiment of the present invention;

FIG. 4 is a diagram illustrating a method of operating a portable terminal in an image processing method according to an exemplary embodiment of the present invention; and

FIG. 5 is a diagram illustrating a method of operating a vehicle electronic device in an image processing method according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

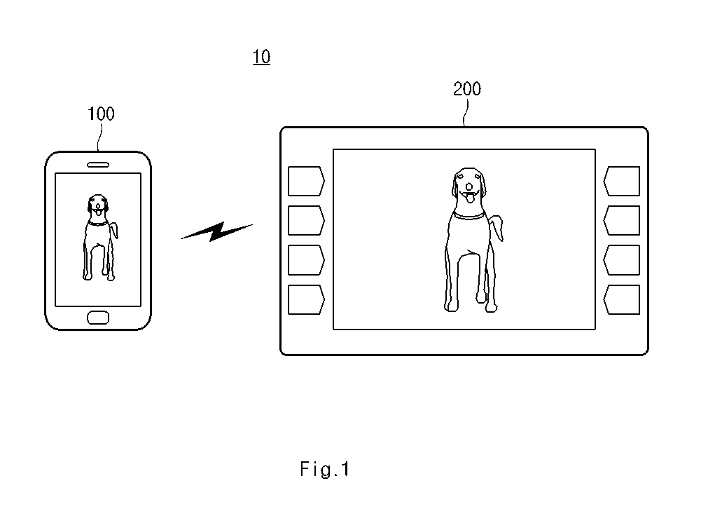

FIG. 1 is a diagram schematically illustrating a configuration of an image processing system according to an exemplary embodiment of the present invention.

Referring to FIG. 1, an image processing system 10 of the present invention may include a configuration of a portable terminal 100 and a vehicle electronic device 200.

The image processing system 10 including such configuration may share resolution and ratio information of the display devices between the portable terminal 100 and the vehicle electronic device 200. After the portable terminal transmits a dummy image to the vehicle electronic device 200, the vehicle electronic device 200 may generate an image size of the dummy image and transmits to the portable terminal 100 when the image size of the dummy image is adjusted to fit to vehicle electronic device's own display area. Accordingly, the image processing system 10 may receive and output the image that is adjusted to fit to the display area of the vehicle electronic device 200.

The portable terminal 100 may draw the dummy image corresponding to the maximum rectangle size that can be output to its own display device, and may transmit the drawn dummy image to the vehicle electronic device 200. Alternatively, the portable terminal 100 may also adjust the size of the dummy image by applying the resolution and ratio information of the vehicle electronic device 200, and may transmit a corresponding dummy image to the vehicle electronic device 200. The portable terminal 100 may generate an optimized UI image by using the actual size information transmitted by the vehicle electronic device 200 and the screen size of the vehicle electronic device 200. In addition, the portable terminal 100 may transmit the generated image information along with the size and actual screen coordinates.

The vehicle electronic device 200 may verify the actual size that may fit to its own display area by processing the dummy image transmitted by the portable terminal 100, and delivers again to the portable terminal 100. The vehicle electronic device 200 may display its own screen by using an image data, size, and coordinates received from the portable terminal 100. Additionally, the vehicle electronic device 200 may receive and output the adjusted image from the portable terminal 100, but may perform a scaling to be fit to the display area size.

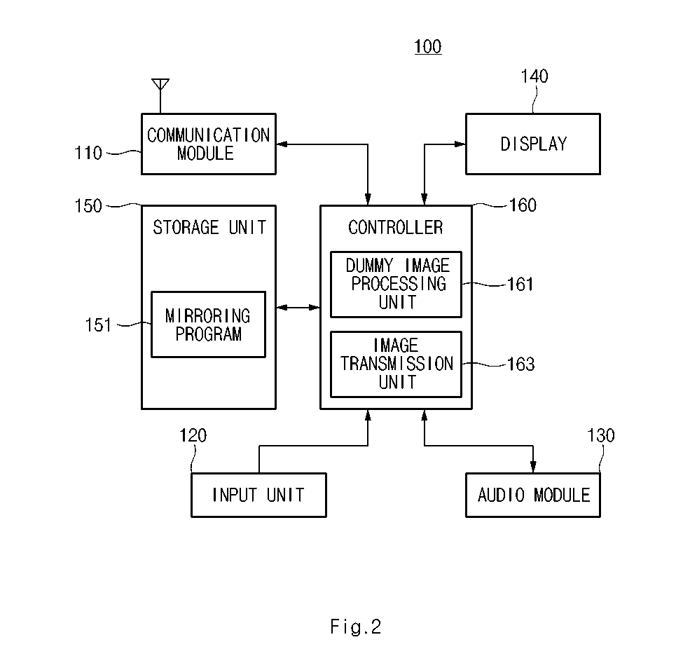

FIG. 2 is a diagram schematically illustrating a configuration of a portable terminal in an image processing system configuration according to an exemplary embodiment of the present invention.

Referring to FIG. 2, the portable terminal 100 of the present invention may include a communication module 110, an input unit 120, an audio module 130, a display unit 140, a storage unit 150, and a controller 160.

The portable terminal 100 having such configuration may form a communication channel with a vehicle electronic device 200 by using the communication module 110, and may output the adjusted image that may be applied to the display device of the vehicle electronic device 200.

The communication module 110 may form the communication channel with a vehicle communication module provided in the vehicle electronic device 200. Such communication module 110 may be at least one of a wired communication modem supporting a wired method, or a wireless communication modem supporting a wireless method. When the communication module 110 includes the wired communication modem, the image processing system may further include a cable device for a signal transmission between the communication module 110 of the portable terminal 100 and the vehicle communication module 210. When the communication module 110 supports the wireless communication method, the communication module 110 may support a certain communication method which can perform the image signal transmission, for example, at least one of the various local area communication methods such as a Bluetooth communication method or a Wi-Fi direct communication method, etc. Such communication module 110 may receive a resolution and ratio information of a vehicle display module 240 from the vehicle electronic device 200, and may deliver the resolution and ratio information of the portable terminal 100 to the vehicle electronic device 200. In addition, the communication module 110 may deliver the dummy image corresponding to an entire size of the vehicle display module 240 to the vehicle electronic device 200, and may receive image size information according to the corresponding dummy image processing result from the vehicle electronic device 200. The communication module 110 may deliver the specific image signal designated by a user to the vehicle electronic device 200.

The input unit 120 may generate various input signals related to the operation of the portable terminal 100. For example, the input unit 120 may generate an input signal to play a specific file stored in the Storage unit 150, or an input signal to perform an internet access, and an input signal to enter to a mirroring mode requesting to transmit to the vehicle electronic device 200 that is being outputted to the display unit 140. In addition, the input unit 120 may generate an input signal to terminate the mirroring mode, and an input signal to terminate a function or to enter into a sleep status of the portable terminal 100. The input signal generated by the input unit 120 is delivered to the controller 160, and may be operated as a command language set to support the corresponding function.

The audio module 130 may output various audio signals generated during the operation of the portable terminal 100. In addition, the audio module 130 may support a function collecting a sound signal when the portable terminal 100 supports a call function. To this end, the audio module 130 may include at least one of a speaker and a microphone. Such audio module 130 may output a notification signal notifying a connection with the vehicle electronic device 100, an audio signal included in the playing image, and the notification signal instructing the termination of the function. The output of the audio signal or the notification signal may be omitted according to a user control.

The display unit 140 may output various screens according to the operation of the portable terminal 100. For example, the display unit 140 may output a standby screen and a menu screen of the portable terminal 100. In particular, the display unit 140 may output a screen which includes an icon for a mirroring menu selection or a menu list. In addition, the display unit 140 may output a screen for a specific file play, or a screen that is configured with a broadcast signal or a streaming signal received from an external. The display unit 140 may output a message notifying connection of the vehicle electronic device 200. The display unit may output an adjusted image corresponding to the screen area of the vehicle electronic device 200. The display unit 140 may output the image corresponding to its own screen area. The display unit 140 may output the message related to a mirroring function release at the time of mirroring function release with the vehicle electronic device 200.

The storage unit 150 may store various application programs or an App related to the operation of the portable terminal 100, or a data according to the corresponding App operation. For example, the storage unit 150 may store various Apps such as an operating system to operate the portable terminal 100, a file play App to play the file, and a broadcast reception App, etc. In particular, the storage unit 150 may store a mirroring program 151. The mirroring program 151 may include a routine outputting an icon to enter to a mirroring mode or a menu list, a routine collecting resolution and ratio information of the vehicle display module 240 at the time of entering to the mirroring mode, a routine transmitting the dummy image corresponding to an entire size area of the display unit 140 to the vehicle electronic device 200, a routine generating an image adjusted based on the information received from the vehicle electronic device 200, and a routine transmitting the adjusted image to the vehicle electronic device 200.

The controller 160 may perform signal processing and data processing that are necessary to operate the portable terminal 100. In particular, the controller 160 may control a signal processing to support the mirroring function of the portable terminal 100, a dummy image processing, an image signal controlling, and a transmission of the adjusted image. To this end, the controller 160 may include a dummy image processing unit 161 and an image transmission unit 163.

When the performing of mirroring function is requested, the dummy image processing unit 161 may verify whether the vehicle electronic device is connected, and may generate the dummy image related to the entire screen area size of the display unit 140 when the vehicle electronic device 200 is connected. In addition, the dummy image processing unit 161 may transmit the generated dummy image to the vehicle electronic device 200. To this end, the dummy image processing unit 161 may perform control of communication module 110 to connect with the vehicle electronic device 200. In addition, the dummy image processing unit 161 may collect resolution and ratio information of the vehicle display module 240, and may deliver to the image transmission unit 163.

The image transmission unit 163 may collect the image size information received from the vehicle electronic device 200 according to the dummy image transmission. In addition, the image transmission unit 163 may calculate the image size that can be optimized to the vehicle display module 240 based on the received image size information of the vehicle electronic device 200, and resolution and ratio information of the vehicle display module 240. Further, the image transmission unit may calculate the image size that fits to the ratio of the vehicle display module 240. When such image size is calculated, the image transmission unit 163 may adjust the image size requested to be transmitted to the vehicle electronic device 200 as the calculated size value. The image transmission unit 163 may transmit the adjusted image to the vehicle electronic device 200. When an event to terminate the mirroring function is generated, the image transmission unit 163 may stop the image adjustment, and may control to release the mirroring mode.

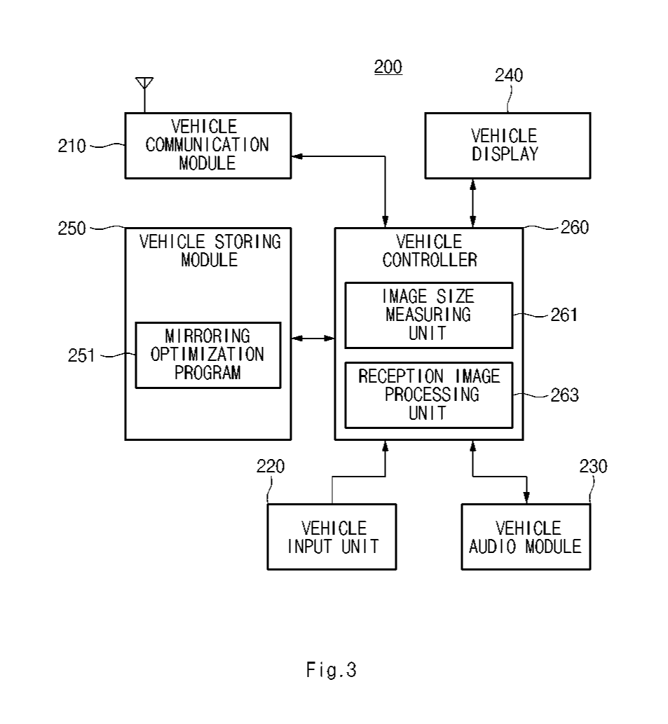

FIG. 3 is a diagram schematically illustrating a vehicle configuration in an image processing system configuration according to an exemplary embodiment of the present invention.

Referring to FIG. 3, the vehicle electronic device 200 according to the present invention may include a vehicle communication module 210, a vehicle input unit 220, a vehicle audio module 230, a vehicle display module 240, a vehicle storing module 250, and a vehicle controller 260.

The vehicle electronic device 200 having such configuration may calculate the image size that fits to the vehicle display module 240 based on the dummy image delivered by the portable terminal 100 in the procedure of the mirroring function performance with the portable terminal 100, and may support to receive and output the optimized image that fits to the vehicle display module 240 by transmitting the calculated image size to the portable terminal 100.

To this end, the vehicle communication module 210 may form the communication channel between the portable terminals 100. The vehicle communication module 210 may include a specific communication modem that is compatible to the communication module 110 of the portable terminal 100. Accordingly, a communication method that is compatible to the communication module 110 such as a wired communication method or a wireless communication method may be applied to the vehicle communication module 210. The vehicle communication module 210 may receive the dummy image from the portable terminal 100, and may transmit the image size information generated based on the dummy image to the portable terminal 100. The vehicle communication module 210 may receive the adjusted image from the portable terminal 100. Additionally, the vehicle communication module 210 may transmit resolution and ratio information of the vehicle display module 240 to the portable terminal 100. The resolution and ratio information may be delivered as initial information in the procedure forming the communication channel.

The vehicle input unit 220 may generate various input signals to control the vehicle electronic device 200. For example, the vehicle input unit 220 may generate an input signal to turn-on the vehicle electronic device 200, an input signal to turn-off the vehicle electronic device 200, an input signal to request the mirroring mode entry, an input signal requesting the mirroring mode release, and an input signal requesting a stopping of the adjusting image signal output. Additionally, the vehicle input unit 220 may generate an input signal to control an audio signal volume included in the received image signal, and an input signal to control a play of the received image signal. The vehicle input unit 220 may be provided as a form of a button or a touch key in order to generate various input signals to control the vehicle electronic device 200.

The vehicle audio module 230 may output various audio signals generated during the operation of the vehicle electronic device 200. For example, the vehicle audio module 230 may perform the output of the various audio signals such as a guidance message guiding the communication connection with the portable terminal 100, a guidance message guiding the mirroring entry, various audio signals included in the received image signal, and a guidance message guiding the mirroring mode release. The output of the audio signal or audio message of the vehicle audio module 230 may be omitted according to a user control.

The vehicle display module 240 may output various screens related to the operation of the vehicle electronic device 200. For example, the vehicle display module 240 may output a recorded image or a screen corresponding to a booting processing environment of the vehicle electronic device during a booting procedure. In addition, the vehicle display module 240 may output various screens according to the characteristics of the vehicle electronic device 200, for example, a navigation screen or a broadcast reception screen, etc. In particular, the vehicle display module 240 may output the mirroring entry screen, a connection screen with the portable terminal 100, and a screen outputting the adjusted image received from the portable terminal 100. The vehicle display module 240 may output the screen performed before the mirroring entry at the time of releasing the mirroring mode.

The vehicle storing module 250 may store a data or a program related to the operation of the vehicle electronic device 200. For example, the vehicle storing module 250 may store the program supporting a navigation program or a broadcast reception function. In particular, the vehicle storing module 250 may store the mirroring optimization program 251. The mirroring optimization program 251 may include a routine supporting the communication channel formation in the communication connection with the portable terminal 100, a routine calculating the image size based on the received dummy image and the size of the vehicle display module 240, a routine delivering the image size information to the portable terminal 100, and a routine outputting the adjusted image delivered by the portable terminal 100. Additionally, the mirroring optimization program may further include a scaling routine adjusting the size of the adjusted image to be fit to the size of the vehicle display module 240.

The vehicle controller 260 may perform a control signal processing and a data processing to operate the vehicle electronic device 200. For example, the vehicle controller 260 may support the various signals processing related to the mirroring function. To this end, the vehicle controller 260 may include an image size measuring unit 261 and a reception image processing unit 263.

The image size measuring unit 261 may control the communication channel formation with the portable terminal 100 by controlling the vehicle communication module 210 at the time of requesting the mirroring function performance. The image size measuring unit 261 may perform the image processing of the dummy image transmitted by the portable terminal 100. In addition, the image size measuring unit 261 may perform the size measuring of the image processed dummy image. The image size measuring unit 261 may transmit the size information of the image that has been image processed by the vehicle electronic device 200 to the portable terminal 100.

When the adjusted image is received from the portable terminal 100, the reception image processing unit 263 may control to output the received adjusted image to the vehicle display module 240. In this procedure, the reception image processing unit 263 may control the adjusted image transmitted by the portable terminal 100, and the output of the adjusted image based on coordinates information and the resolution and the ratio of the vehicle display module 240. The reception image processing unit 263 may further perform the scaling of the adjusted image to make the adjusted image to be fit to the screen area of the vehicle display module 240 in the procedure of applying the resolution and the ratio. The coordinate information transmitted by the portable terminal 100 may include a left and right diagonal direction coordinates of the image.

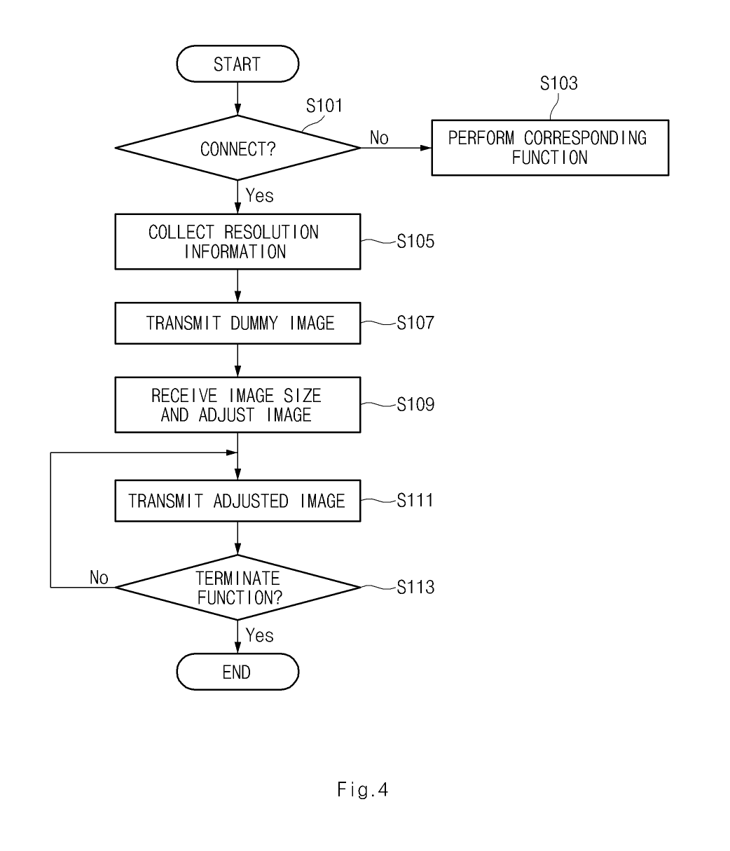

FIG. 4 is a diagram illustrating a method of operating a portable terminal in an image processing method according to an exemplary embodiment of the present invention. Referring to FIG. 4, in the method for operating the portable terminal for an image processing of the present invention, the controller 160 of the portable terminal 100 may verify whether a connection with the vehicle electronic device 200 is generated at step 101. When the connection with the vehicle electronic device 200 is not generated at step S101, the controller 160 may support to perform a corresponding function according to a generated event at step S103. The connection method may be at least one of the various connection methods such as a HDMI, MHL, etc.

When the connection with the vehicle electronic device 200 is performed at step S101, the controller 160 may perform a collection of resolution and ratio information of the vehicle electronic device 200 at step S105. For example, the portable terminal 100 may receive 720P (pixel) information as resolution information of the vehicle electronic device 200.

At step S107, the controller 160 may perform the dummy image transmission. At this time, the portable terminal 100 may generate and transmit the dummy image as 1280×720 corresponding to resolution information of the vehicle electronic device 200 when the resolution of the display unit 140 is, for example, 1280×800.

At step S109, the controller 160 may perform the image size reception and the image adjusting. When the vehicle electronic device 200 receives the dummy image from the portable terminal 100, the vehicle electronic device 200 may perform an image-processing for the received dummy image, and calculates the image size that fits to the size of the vehicle display module 240. For example, when the vehicle electronic device 200 receives 1280×720 image, the vehicle electronic device may calculate 1152×720 image size according to an image processing method that operates to fit to the resolution of its own vehicle display module 240, and may transmit the calculated image size to the portable terminal 100. The controller 160 of the portable terminal 100 may perform the image adjusting based on the resolution and ratio of the vehicle electronic device 200 when the image size information is received from the vehicle electronic device 200. For example, in case of 1422×800 image, it may be displayed as 1280×720, and such image may be adjusted as the image of the size of 888×666 according to the image size information.

At step S111, the controller 160 may perform the adjusted image transmission. To this end, the controller 160 may transmit the image of the adjusted size to the vehicle electronic device 200 through the communication module 110. At this time, the controller 160 may transmit a left and right diagonal direction coordinates of the image to the vehicle electronic device 200.

At step S113, the controller 160 may verify whether an event to terminate a function is generated. When the event to terminate a function is not generated at this step, the controller 160 may support to repeat the next procedure by proceeding to step S111.

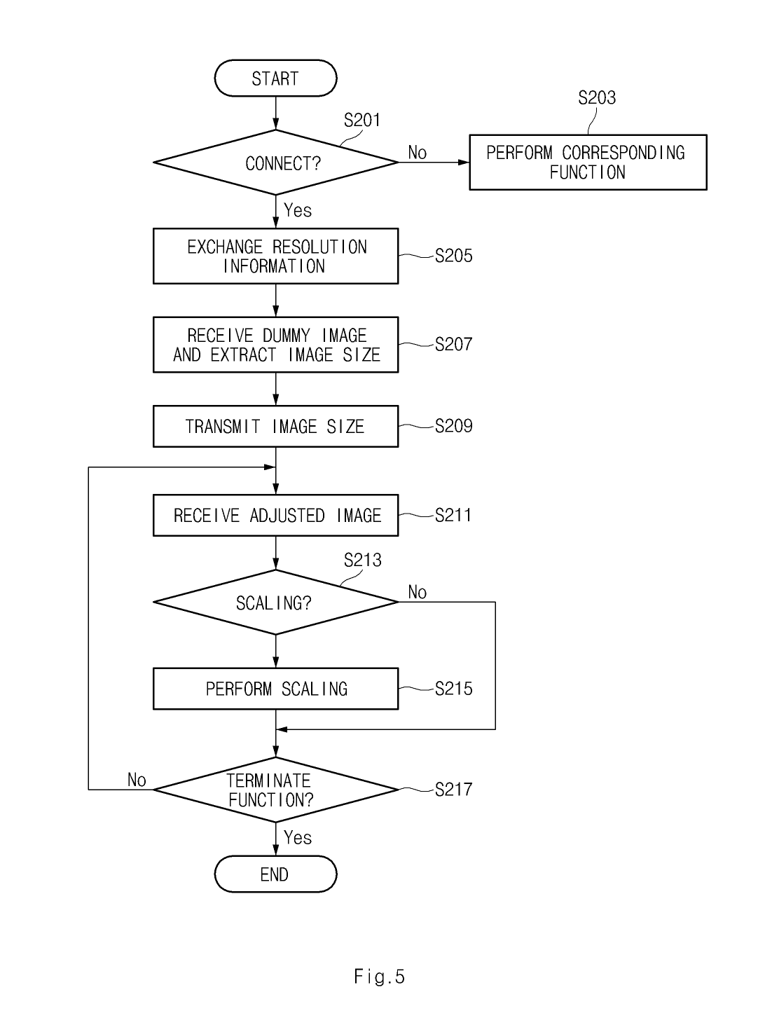

FIG. 5 is a diagram illustrating a method of operating a vehicle electronic device in an image processing method according to an exemplary embodiment of the present invention.

Referring to FIG. 5, in the vehicle electronic device operating method to process the image of the present invention, first, the vehicle controller 260 may verify whether the connection with the portable terminal 100 is generated at step S201. When the connection with the portable terminal is not generated at step S201, the vehicle controller 260 may perform a corresponding function related to the operation of vehicle electronic device 200 at step S203. As described above, various methods such as a HDMI, MHL, and the like may be used for the connection procedure.

When the connection with the portable terminal 100 is generated at step S201, the vehicle controller 260 may perform resolution information exchange at step S205. At this time, the vehicle controller 260 may transmit resolution and ratio information of the vehicle display module 240 to the portable terminal 100.

Next, the vehicle controller 260 may perform the dummy image reception and the image size extraction at step S207. The vehicle controller 260 may receive the dummy image related to the information of the image of the size to be output by the portable terminal 100, or the dummy image that guides the image size outputted on the display unit 140 of the portable terminal 100. Here, the dummy image may have a size to which the resolution and the ratio of the vehicle electronic device 200 is applied based on the image size to be output to the portable terminal 100.

At step S209, the vehicle controller 260 may transmit the image size to the portable terminal 100. At this time, the vehicle controller 260 may perform the image processing of the dummy image, and may measure the image size information of the certain size that is applicable to the vehicle display module 240. In addition, the vehicle controller 260 may transmit the measured image size information to the portable terminal 100 through the vehicle communication module 210.

At step S211, the vehicle controller 260 may receive the adjusted image from the portable terminal 100. At this time, the adjusted image received from the portable terminal 100 may have a size that is calculated based on the resolution of the vehicle display module 240 and the measured image size information, and may include the left and right diagonal direction coordinates information of the image.

Next, the vehicle controller 260 may verify whether the scaling is required at step S213. At this step, the vehicle controller 260 may determine whether the scaling of the adjust image is performed by comparing a size of the received adjusted image and a size of the vehicle display module 240.

At step S213, when the scaling is required, the vehicle controller 260 may perform the scaling procedure suitable to the vehicle display module 240 at step S215. Meanwhile, when the scaling is not required at step S213, the vehicle controller 260 may skip the step S215.

Next, the vehicle controller 260 may verify whether the event to terminate a function is generated at step S217. When the event to terminate a function is not generated at step S217, the vehicle controller 260 may control to repeat the next procedure by proceeding to step S211.

As described above, in the image processing method and system, and the vehicle electronic device and the portable terminal supporting the same according to an exemplary embodiment of the present invention, the portable terminal may generate and transmit the dummy image based on the resolution of the vehicle electronic device and the display unit size of the portable terminal, and may calculate and apply the image size to be applied to the vehicle display module according to the image processing of the dummy image. As a result, the present invention may implement the adjusted image generated from the portable terminal to have a size optimized to the vehicle electronic device, such that the occurring of a screen cutoff, a blank space occurring, and a UI distortion, and the like may be prevented. The present invention is applicable to all connectivity technologies which are based on the mirroring such as MHL/DHMI/Miracst/MirrorLink, and the like.

Likewise, according to the image processing method and system, and the vehicle electronic device and the portable terminal supporting the same, the present invention may display the optimized UI and screen through an image optimization algorithm even though the portable terminal and the vehicle electronic device which have a different resolution/ratio are connected.

In addition, regardless of the characteristics of the display device of each manufacturer of the portable terminal, the present invention may properly display the information displayed on the portable terminal based on the resolution and the optimization algorithm obtained through mutual communication, thereby, improving a screen distortion phenomenon such as screen cutoff, a blank space occurring, a UI distortion, and the like.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A system for processing an image, the system comprising:
a portable terminal configured to generate a dummy image based on resolution information of a vehicle electronic device and a size of its own display unit to transmit to the vehicle electronic device, and transmits an adjusted image depending on an image size based on the dummy image transmitted by the vehicle electronic device; and
a vehicle electronic device configured to calculate the image size based on the dummy image to transmit to the portable terminal, and receive and output the adjusted image transmitted by the portable terminal.

2. The system of claim 1, wherein the portable terminal adjusts the dummy image so that a resolution size of the display unit may be fit to the resolution of the vehicle electronic device.

3. The system of claim 1, wherein the portable terminal transmits a left and right diagonal direction coordinates value of the adjusted image along with the adjusted image.

4. The system of claim 3, wherein the vehicle electronic device outputs the adjusted image to a vehicle display module based on the direction coordinates value.

5. The system of claim 3, wherein the vehicle electronic device performs a scaling of the adjusted image based on a size comparison of the adjusted image and the vehicle display module.

6. A portable terminal supporting an image process, the portable terminal comprising:
a communication module configured to form a communication channel with a vehicle electronic device; and
a controller configured to receive resolution information of the vehicle electronic device through the communication module, generate a dummy image based on the resolution information of the vehicle electronic device and a size of the portable terminal's own display unit to transmit to the vehicle electronic device, and generate and transmit an adjusted image depending on an image size based on the dummy image transmitted by the vehicle electronic device and a resolution of the vehicle electronic device.

7. The portable terminal of claim 6, wherein the controller generates a dummy image having a maximum size of resolution of the display unit, or generates a dummy image obtained by adjusting a size corresponding to the resolution of the display unit to the resolution of the vehicle electronic device.

8. The portable terminal of claim 6, wherein the controller controls a left and right diagonal direction coordinates value of the adjusted image to be transmitted along with the adjusted image.

9. The portable terminal of claim 6, wherein the communication module performs a mirroring data transmission based on HDMI or MHL.

10. A vehicle electronic device supporting an image processing, the vehicle electronic device comprising:
a vehicle communication module configured to form a communication channel with a portable terminal and;
a vehicle controller configured to transmit resolution information of a vehicle electronic device through the vehicle communication module, receive a dummy image generated based on the resolution information of the vehicle electronic device and a display unit size of the portable terminal from the portable terminal to perform an image processing and transmit a measured image size to the portable terminal, and receive an adjusted image from the portable terminal; and
a vehicle display module configured to output the adjusted image.

11. The vehicle electronic device of claim 10, wherein the vehicle controller controls an output of the adjusted image by using a left and right diagonal direction coordinates value of the image received along with the adjusted image.

12. The vehicle electronic device of claim 10, wherein the vehicle controller performs a scaling of the adjusted image based on a size comparison of the adjusted image and the vehicle display module.

13. The vehicle electronic device of claim 10, wherein the vehicle communication module performs a mirroring data reception based on HDMI or MHL.

14. A method of processing an image, the method comprising:
forming a communication channel with a portable terminal by a vehicle electronic device;
receiving a dummy image generated based on a resolution of display unit of the portable terminal by the vehicle electronic device;
calculating an image size by image processing the dummy image by the vehicle electronic device;
transmitting the image size to the portable terminal by the vehicle electronic device;
receiving an adjusted image obtained by adjusting a size based on the image size by the vehicle electronic device; and
outputting the received adjusted image by the vehicle electronic device.

15. The method of claim 14, wherein the receiving of the adjusted image further comprises receiving a left and right diagonal direction coordinates value of the adjusted image.

16. The method of claim 15, further comprising performing performs a scaling of the adjusted image based on a size comparison of the adjusted image and the vehicle display module of the vehicle electronic device.
